(19) United States
(12) Patent Application Publication
(10) Pub. No.: US 2025/0029150 A1
(43) Pub. Date: Jan. 23, 2025

(54) METHOD AND SYSTEM FOR DIGITAL SEARCH OPTIMIZATION

(71) Applicant: AIQUIRE INC., Chicago, IL (US)

(72) Inventors: Vrushali Prasade, Bengaluru (IN); Satyam Vivek, Bengaluru (IN); Chinmay Patel, Bengaluru (IN); Rohtash Beniwal, Bengaluru (IN); Shubham Mishra, Bengaluru (IN); Vivek Vishwas Vichare, Bangalore (IN)

(73) Assignee: AIQUIRE INC., Vernon Hills, IL (US)

(21) Appl. No.: 18/709,458

(22) PCT Filed: Sep. 7, 2022
(86) PCT No.: PCT/US2022/042784

§ 371 Date: May 10, 2024

(30) Foreign Application Priority Data
Nov. 13, 2021 (IN) 202141052159

(51) Int. Cl. G06Q 30/0251

(52) U.S. Cl. CPC G06Q 30/0271

(57) ABSTRACT

An AI-enabled digital search optimization system is described. The system includes a clustering module configured to cluster a set of keywords into one or more clusters. The system further includes a targeting AI module configured to determine a target audience cohort for a corresponding one of the at least one cluster. The system further includes an advertisement (ad) copy generation module configured to generate a personalized ad copy to the determined target audience. Herein each personalized ad copy comprises a headline and a description, wherein the headline and the description have at least one keyword from the corresponding one of the at least one cluster.

### RELATED APPLICATION(S)

This application claims priority from the Indian Provisional Patent Application No. 202141052159, filed on Nov. 13, 2021, and titled “A Method And System For Digital Search Media Optimization,” which is hereby incorporated by reference, in its entirety.

### FIELD OF THE INVENTION

The embodiments herein generally relate to digital search optimization. In particular, the embodiments presented relate to a method and system for digital search optimization for online advertisement (ad) campaigns.

### BACKGROUND OF THE INVENTION

Customers generally discover products or services online by performing keyword search on online search engines. The sellers/advertisers of such products or services want their keywords to appear among the most searched keywords by the customers (target audience) and therefore, generate ad copies for the customers based on these keywords. However, there is no mechanism to efficiently customize these ad copies according to the needs and interests of the target audience. This results in the advertiser researching/bidding on several irrelevant keywords to generate the ad copies, which further leads to lack of desired performance of the associated ads.

Further, ad campaigns need to be periodically monitored manually to optimize various ad parameters (e.g. keywords, target audience, ad positioning on web page etc.) and to identify ad copies which need to be continually changed/updated for maintaining the performance of the ad campaigns. This requires substantial manual effort to generate variant ad-copies by manually updating them to cater to needs and interests of the target audience. This may also result in human errors and may not optimize the ad campaign. In addition, such conventional approaches consume substantial computational and monetary resources, which is undesirable.

Therefore, there is a need to overcome the above-described challenges for digital search optimization of keywords.

### OBJECTS OF THE INVENTION

An objective of the embodiments presented herein is to provide an AI-enabled digital search optimization system and a corresponding method to provide personalized ad recommendations for relevant target audience and accordingly, enhance user experience. Another objective of the embodiments presented herein is to increase conversions among the customers by increasing the probability of their interaction with the ads.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY OF THE INVENTION

Embodiments of an AI-enabled digital search optimization system and a corresponding method are disclosed that address at least some of the above challenges and issues.

In accordance with the embodiments of this disclosure, an AI-enabled digital search optimization system is described. The system includes a clustering module configured to cluster a set of keywords into one or more clusters. The system further includes a targeting AI module configured to determine a target audience cohort for a corresponding one of the at least one cluster. The system further includes an advertisement (ad) copy generation module configured to generate a personalized ad copy to the determined target audience cohort. Herein, each personalized ad copy comprises a headline and a description, wherein the headline and the description have at least one keyword from the corresponding one of the at least one cluster.

### BRIEF DESCRIPTION OF THE DRAWINGS

Further advantages of the invention will become apparent by reference to the detailed description of preferred embodiments when considered in conjunction with the drawings:

FIG. 1 illustrates a digital search optimization system, according to an embodiment.

FIG. 2 illustrates a flowchart for a method for digital search optimization, according to an embodiment.

FIG. 3 illustrates a block diagram to illustrate an exemplary scenario for digital search optimization, according to an embodiment.

FIG. 4 illustrates an exemplary implementation of an ad copy generation module, according to an embodiment.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure.

A “keyword” may refer to a word or a phrase that may be provided as an input to an online search engine to search for online resources such as, but not limited to, online articles, video content, images, websites, products, and/or services associated with the keyword.

A “cluster” may be defined as a group of keywords categorized based on one or more factors such as, but not limited to, name of each keyword, meaning of each keyword, an associated brand name, online search volume of each keyword (e.g. average monthly searches of the keyword), and a relevance of each keyword with a specific topic, an associated product and/or service, an interest of target audience in the product and/or service, a season or an event, and one or more concept fields (e.g. user-defined tags) associated with each keyword.

An “ad copy” may refer to textual and/or visual content included in an online ad that may be displayed to a user. The ad copy may include a headline and a description associated with a product and/or service associated with an online ad. The ad copy may prompt a user to interact with the ad to view or purchase the associated product and/or service. In one example, the online ad may be a part of an online ad campaign that may be deployed on a social media platform, a search engine, or any other website by an advertiser. The online ad campaign may include one or more online ads, related to one or more products and/or services. Each ad may have one or more associated ad copies.

A “target audience” may refer to a specific group of consumers that are likely to purchase a product and/or service associated with an online ad. The target audience may be grouped into “target audience cohorts” based on one or more parameters such as, but not limited to, age, gender, interests, geographical location, user profiles, browsing history, brand loyalty, and so on. The target audience cohorts may be segments of target audience that can be grouped together based on various parameters such as, but not limited to, age, gender, geographical location, interests, and demographics.

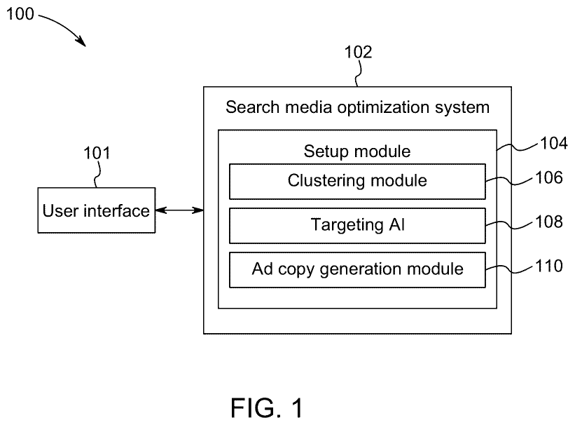

These and other embodiments of the methods and systems are described in more detail with reference to FIGS. 1-4.

FIG. 1 illustrates an artificial-intelligence (AI)-enabled system 100 that may include a digital search optimization system 102, according to an embodiment. In this embodiment, the digital search optimization system 102 may include a setup module 104 that may further include a clustering module 106, a targeting AI module 108, and an ad copy generation module 110. In an embodiment, the digital search optimization system 102 may be in communication with a user interface 101. The user interface 101 may enable the digital search optimization system 102 to receive user inputs and display outputs generated by the digital search optimization system 102, to the user.

A person skilled in the art would understand that the above-mentioned modules are described only for illustrative purposes and the illustrated embodiments are not restricted to the illustrated number or types of modules. Fewer or more number or types of modules may be implemented depending on the design requirement of the embodiments presented herein. The digital search optimization system 102 may be integrated as a software or hardware module with a conventional search engine, social media platform, or a keyword research platform to implement the embodiments presented herein.

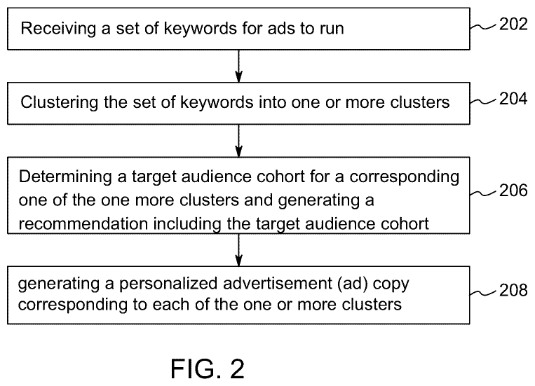

FIG. 2 illustrates a flowchart for a method 200 for digital search optimization, according to an embodiment. In some embodiments, this method 200 may be performed by the digital search optimization system 102.

In step 202, the clustering module 106 may receive a set of keywords for a group of online ads to run as a part of one or more ad campaigns. For instance, the keywords may be received from one or a user, a search engine, or a social media platform. In one example, an advertiser may intend to present the online ad to a relevant target audience to cater to the interests of the target audience. In one example, if the advertiser intends to display an ad related to ‘pizza’, some related keywords may include, but not limited to, ‘pizza’, ‘fast food’, ‘hunger’, and/or any other related keywords that convey the underlying message as ‘pizza’. Similarly, an ad associated with a credit card may be associated with keywords such as ‘credit card’, ‘finance’, ‘credit’, ‘loan’ and so on.

In an embodiment, these keywords may be generated manually by a user (e.g. the advertiser of the ad campaign) and provided to the clustering module 106 as a user input via the user interface 101 (e.g. in a comma-separated values (CSV) file). Alternatively or additionally, these keywords may be automatically generated by a keyword research tool (e.g. a keyword research website or an application) based on a topic/theme provided by the user (e.g. ‘pizza’ or ‘credit card’) to the keyword research tool. The keyword research tool may then provide a set of such keywords to the clustering module 106 based on a user input to perform this action.

On receiving the set of keywords, the clustering module 106 may cluster the set of keywords into one or more clusters, in step 204 (for example, the clustering module 106 may extract and receive the keywords from the uploaded CSV file or by any other known methods of extracting keywords). In an exemplary scenario, the keywords may be clustered into the following categories:

Clustering based on brand names and competitors—For this type of clustering, the clustering module 106 may analyze concept fields associated with each keywords in the set of keywords to identify brand names associated with these keywords, in a specific industry. For example, the clustering module 106 may analyze 50 keywords associated with e-commerce industry to identify 3 most popular brand names associated with the keywords. The set of 50 keywords may be thus, be categorized into 3 different brand-based clusters. For example, the brand-based clusters may be, but not limited to, “Brand A's New Year Sale”, “Brand B's Savings Day”, and “Brand C's 2-hour delivery guarantee”, and so on based on keywords such as “sale”, “discount”, “New Year”, “e-commerce”, “delivery” and so on. Each cluster may have overlapping keywords with other clusters. In an optional embodiment, the clustering module 106 may additionally form clusters based on competitor names. For example, may be “Slow delivery by major players” or “Expensive products by conventional companies” based on keywords such as “Brand D”, “e-commerce” and “delivery”, wherein Brand D may be the competitor of “Brand A”.

In an optional embodiment in the above example, the clustering module 106 may subsequently, execute a web scrapper (not shown) to retrieve all brand names associated with the e-commerce industry to validate the set of 50 keywords. The clustering module 106 may accordingly filter out any junk values that are not validated.

Here, the keywords from the set of keywords that are associated with the 3 brand names are included in one or more clusters.

Clustering based on Products and Interest: This type of clustering may be performed by the clustering module 106 when the set of keywords communicate a common idea of a specific product or product interest of target audience. For example, a cluster including keywords such as “sneakers”, “sports shoes”, “floaters”, “comfort footwear” may be tagged as “casual shoes”. Another cluster may include keywords such as “beach footwear”, “flip flops”, and “slippers” may be tagged as “sandals” or “slippers”. For this categorization, the clustering module 106 may determine those keywords for a cluster that have a similar set of meaning and communicate a similar message/idea that is of interest to a potential target audience based on the semantic similarity of the keywords (e.g. ‘casual shoes’ may be a common message communicated by all keywords in the above example related to shoes). In an embodiment, the clustering module 106 may generate vectors (e.g. a one-dimensional array floating numbers) of all the keywords in the set of keywords. Further, the clustering module 106 may generate a similarity matrix of all the generated vectors. From this matrix, the clustering module 106 may determine a pairwise similarity score for all the keywords. Based on the determined similarity score, the clustering module 106 may cluster the keywords.

Clustering based on search volume: For this clustering, the clustering module 106 may cluster the keywords in the set of keywords based on their online search volume on one or more search engines. In an embodiment, the clustering may be of 2 types: Broad clustering and Exact clustering. The keywords having a higher search volume are clustered under an ‘exact cluster’, which means that an associated ad would have a higher probability of being presented to a target user when the exact keyword is searched by the user. Further, the keywords that have a relatively lower search volume may be clustered under a ‘broad cluster’, which means that an associated keyword may be presented to the user when the user searches for keywords partially matching these keywords. The keywords searched by the user need not be an exact match with the ‘broad cluster’ keywords.

Generic clustering: Generic clustering may refer to tagging clusters with generic names, which do not include brand or competitor names. Generic clustering may be implemented when the target audience is not expected to perform keyword search by specific product or brand names.

Season-based clustering: Season-based clustering may refer to tagging clusters based on seasons or events such as, but not limited to, “Diwali Sale”, “Near Year Saving Days”, “Christmas Sale”, and so on.

In an optional embodiment, once the keywords in the set of keywords are clustered, the clustering module 106 may then assign a label to each of the one or more clusters. These labels may be unigram or bigram to suitably represent all keywords in the corresponding cluster. The label may be a name or a tag for the cluster to indicate a common meaning or idea communicated by the keywords in the cluster. In this embodiment, the clustering module 106 may determine that a frequency of occurrence (repetitions) of one or more keywords associated with a specific cluster is above a predetermined threshold, that is, the cluster includes several repetitions of such keywords. The clustering module 106 may also determinate the frequency of occurrence of these keywords in other clusters to determine whether the same keywords occurring in one cluster also occur in other clusters. The clustering module 106 may select the keyword(s) that has the lowest frequency of occurrence in the other clusters i.e., the keyword with the lowest association with other clusters. This is because such keyword(s) may be more relevant to the cluster in which the frequency of occurrence is higher than that of other clusters. The clustering module 106 may accordingly assign this keyword as a label of this cluster.

In an embodiment, the clustering module 106 may provide the assigned labels for all clusters to the user interface 101, which may further display these labels to a user. The user may approve, reject, and/or edit one or more labels by providing a user input to the user interface 101. The user interface 101 may then provide the user input to the clustering module 106, which may accordingly perform operations such as add, remove, and/or edit labels based on the corresponding user input. The clustering module 106 may then provide the labels and corresponding keywords to the targeting AI module 108 and the ad copy generation module 110. In an embodiment, these labels may be the labels that are approved and edited by the user.

In step 206, the targeting AI module 108 may determine a target audience cohort for a corresponding cluster from the one or more clusters and generate a recommendation including the target audience cohort. In one example, the target audience may include potential consumers of the ad that should be targeted for each keyword cluster. The recommendation may include one or more of targeting dimensions associated with the target audience cohorts. This may include, but not limited to, an age group, a gender, a location, and an interest profile associated with the target audience. A person skilled in the art would understand that fewer or more targeting dimensions may be included in the generated recommendation depending on the design requirements of the embodiments presented herein.

In an embodiment, the targeting AI module 108 may discover keywords from a combination of sources including and not limited to external and internal knowledge graphs and databases. These keywords may then be processed by the targeting AI module 108 with technologies including and not limited to Natural Language Processing (NLP)/computational semantics and clustering algorithms to provide the clusters of keywords. In an embodiment, the targeting AI module 108 may provide the clusters of keywords to a semantic matching engine (not shown) in communication with the targeting AI module 108, to determine the target audience cohort(s). The semantic matching engine may be a physical or logical component of the targeting AI module 108, which may then rank keywords, interests, and similar user profiles to determine potential targeting dimensions (e.g. demographics of a target audience) for the advertiser and cluster them to give understandable cohorts.

In one example, an advertiser may intend to run an advertisement for a popular shoe brand ‘Brand S’. There may be 2 clusters of keywords, in this example. The first cluster may include keywords focused on ‘Brand S’ and the second cluster may include keywords focused on sports lovers. The semantic engine may rank keywords related to ‘Brand S’ higher than the keywords related to sports lovers based on their semantic similarity with the first cluster. There may be additional factors such as, but not limited to, search volume or audience size which can be provided as inputs in the ranking methodology.

In an embodiment, the semantic engine may implement and use internal and external knowledge graphs and databases, with technologies such as, but not limited to, NLP, statistical analysis, and Machine Learning models to determine the potential targeting dimensions based on the ranking. In one example, the semantic analysis engine may analyze one or more previous ad campaigns that the advertiser launched on a social media platform or a search engine. The semantic analysis engine may, accordingly, determine historical data associated with such ad campaigns to train the ML-based models, enrich internal knowledge graphs and databases, and recommend relevant target audience for the product/keywords. The ad campaigns analyzed may be associated with similar industries with which the keywords analyzed by the search media optimization system 102 are associated.

The potential targeting dimensions (e.g. target audience cohorts) may include, but not limited to, an age group, a gender, a location, and an interest profile associated with the target audience. The semantic analysis engine may then, provide these target audience cohorts to the targeting AI module 108, which may then generate a recommendation that includes these target audience cohorts.

The targeting AI module 108 may accordingly provide the recommendation of target audience cohorts along with the clusters of keywords to the ad copy generation module 110 for further processing, as described later.

Alternatively or additionally, the targeting AI module 108 may also provide the recommendation to the user interface 101, which may then display the recommendation to a user (e.g. the advertiser).

In step 208, the ad copy generation module 110 may generate a personalized ad copy corresponding to each determined target audience cohort for all clusters of keywords received as input from the targeting AI module 108. This may enable the advertiser to target personalized ad copies catering to the interests of different target audience cohorts associated with various clusters of keywords.

In an embodiment, each such ad copy may include a headline and a corresponding description, which may be personalized for the corresponding target audience cohort received from the targeting AI module 108. This may increase a probability of a target user clicking on the associated ad, which further increases the probability of conversion of each impression of the keywords. In one example, a headline in each ad copy may have a character limit (e.g. 12 characters) and a description in each ad copy may have another character limit (e.g. 30 characters). Further, in this example, the ad copy generation module 110 may generate 4 personalized headlines for each cluster and the user may select one of these headlines to be included in the ad copy for the corresponding cluster. Further, in this example, the ad copy generation module 110 may generate 30 different descriptions for each ad copy and the user may select one description to be included in the ad copy corresponding to the cluster.

In an alternate embodiment, the above-described inputs from the targeting AI module 108 to the ad copy generation module 110 may be optional. For instance, the ad copy generation module 110 may generate the ad copies corresponding to each cluster of keywords based on the cluster labels generated by the clustering module 106. Herein, the clusters may be based on any criteria discussed previously in this disclosure.

To generate the personalized ad copy, the ad copy generation module 110 may identify one or more interest summary keywords in a corresponding cluster based on the above-described inputs from the clustering module 106 and/or the targeting AI module 108. The interest summary keyword for a cluster may identify a common meaning or idea conveyed by all keywords in that cluster. The ad copy generation module 110 may identify these interest summary keywords based on one or more predefined parameters such as a semantic similarity score between the keywords, demographics of target audience, user interest in a keyword, performance of a keyword in a previous ad campaign, and online search volume of a keyword.

In one example, an ad copy for the “Company A” cluster may include a personalized headline as “Want a pocket-friendly pizza?” and a personalized description as “Get 4 toppings starting Rs. 69 from Company A”, for a cost-sensitive target audience. Another ad copy for the “Company B” may include a personalized headline as “Sea-view dining experience” and a description as “Beachside fine-dining Italian cuisine for a great evening!” for a less cost-sensitive audience.

In an exemplary scenario, the ad copy generation module 110 may implement any known pre-trained language module or algorithm to generate the personalized paraphrases for the headline and the description of the ad copy. In one example, the pre-trained language models may include, but not limited to, a Generative Pre-trained Transformer 3 (GPT 3) model, GPT-J model, a GPT-Neo model or Gopher model. A person skilled in the art would understand that any combination or type of such language models may be implemented depending on the design requirements of the embodiments presented herein.

In an embodiment, the ad copy generation module 110 may then perform a relevance check and a grammar check on all such generated paraphrases and select those paraphrases for which the relevance check and grammar check are successful. The ad copy generation module 110 may then generate a headline and a description for the cluster based on the selected paraphrases. The headline and description are generated in a similar manner for each cluster based on the paraphrases corresponding to each cluster.

In an optional embodiment, the ad copy generation module 110 may receive an input including logistical details, from the user regarding the ad copies to incorporate these details in the ad campaign. For example, the logistic details may include one or more levers such as, but not limited to, a tonality and/or emotion of the ad copy, a sentence intent and/or type of the ad copy, a correlation of a text content with an image associated with the ad copy, a discount offer, and a call-to-action (CTA) to be used in the generated ad copy. Some of the examples for such logistical details may include, but not limited to ad copies indicating the paraphrases-‘25% off’, ‘New Year Sale’, ‘Buy 1 get 1 free’, ‘Buy now’, “Book now’, and ‘Free consultation’.

Here, the ad copy generation module 110 may not be aware of the specific type of offer/discount/CTA to be provided in the generated ad copy. Additionally, generating an incorrect offer may result in an unusable copy which may ultimately reduce systems accuracy, increase ad rejection by the user, and therefore, result in lower product satisfaction. The addition of logistical details may prevent these undesired outcomes.

The below table illustrates some non-limiting exemplary scenarios with several levers for the ad copy and the corresponding ad copies:

| Platform | Type of | | |
|---|---|---|---|
| name | ad copy | Lever | Example of ad copy content |
| Social Media | Primary Text | Benefit - Rhetoric | Don't modular kitchens make |
| platform 1 | | Questions | cooking so convenient? |
| Social Media | Headline + | Dramatic Sentences | |
| platform 1 | Primary Text | (Headlines) + | |
| | | Rhetoric Questions | |
| | | (Primary Text) | |
| | | Core Benefit | Modular Kitchens that'll make |
| | | | cooking experience enjoyable! |
| | | Expected Benefit | Modular Kitchens that'll make |
| | | | cooking so convenient! |
| | | Augmented Benefit | Modular Kitchens that'll last a |
| | | | lifetime |
| | | Question | Looking for Modular Kitchens? |
| | | CTA (Call to action) | Install app now for getting |
| | | | suggestions on Modular Kitchens |
| | | Social Proof | USA's most trusted Modular |
| | | | Kitchen makers |
| | | Price | Exquisite Modular Kitchens |
| | | | starting @ $3000 |
| | | Solution Focussed | Modular Kitchens that best utilize |
| | | | your space |
| | | Variety Focussed | U-shaped, L-shaped, Island |
| | | | Modular Kitchens |
| | | Risk Focussed | Get a 100% refund if you don't like |
| | | | our Modular Kitchen |
| Social Media | Headline + | Effort Focussed | Our Modular Kitchen Experts will |
| Platform 2 | Primary Text | | handle it all while you sit back and |
| | | | relax |
| | | Curiosity Focussed | Why does everyone love our |
| | | | Modular Kitchens? |
| | | Audience Focussed | Your wife will love our Modular |
| | | | Kitchens |
| | | Interest Focussed | Add a traditional touch to your |
| | | | modern kitchen |
| | | Beauty | Italian Modular Kitchen Designs to |
| | | | steal your heart away! |
| | | Doubt | Is it really worth investing in our |
| | | | Modular Kitchens? |
| | | Negative Statement | Modular Kitchen is all hype! Says |
| | | | the one that lacks taste! |
| | | Individual Focussed | Modular Kitchen Designs that |
| | | | reflect your personality |
| | | Insight | 40% of newly working couples opt |
| | | | for a Modular Kitchen |
| | | Different/Custom | Modular Kitchens customized to |
| | | | Your Taste |
| | | Imaginative | Modular Kitchens with Hidden Bar |
| | | | Cabinets. Why not? |
| | | Enthusiasm | Surprise! Enter the Contest & Win |
| | | | a Modular Kitchen. |
| | | Fear of missing | Last chance to get a Modular |
| | | out (FOMO) | Kitchen done for $2000 INR. |
| | | | Hurry! |
| | | Transformational | Challenging the old ideas: Tired of |
| | | | cookie-cutter Modular Kitchen |
| | | | Designs? Design your own, now! |
| | | Antithesis | Love your old kitchen? You'll love |
| | | | your new kitchen even more. |
| | | | Adore your kitchen? Not once you |
| | | | see ours! |
| | | Triadic Sentence | Date; Design; Done - Getting your |
| | | | modular kitchen is that simple! |
| | | | Have a date with our design expert, |
| | | | confirm the design and we'll get it |
| | | | done for you! |
| | | Inverted Sentence | For you alone, we'll create a unique |
| | | | Modular Kitchen design! |
| | | Satirical | Knives, Scissors, Ice-breakers - But |
| | | | for these, we'll deliver a safe |
| | | | Modular Kitchen! |
| | | Occasion Focussed | Gift your wife a Modular Kitchen |
| | | | this Valentine's Day |
| | | Vernacular | Hola Spain! Ready to check out |
| | | | Modular Kitchens? |
| | | | Great Modular kitchen deals for |
| | | | Spaniards. |
| | | Movie Related/ | Vinterior Modular Kitchens: The |
| | | Meme Related | stuff that dreams are made of! |
| | | | Even Hobbits love us. Cute & |
| | | | Compact Modular Kitchens from |
| | | | Vinteriors! |
| | | Competitor | Our 10-year warranty doesn't come |
| | | Sledging | with a fine-print. |
| | | | Live your space with better interior |
| | | | designs! |

The personalized ad copies generated by the above-described method may then be presented as an online ad to users in the target audience cohort when the audience searches for specific keywords in or related to the corresponding clusters.

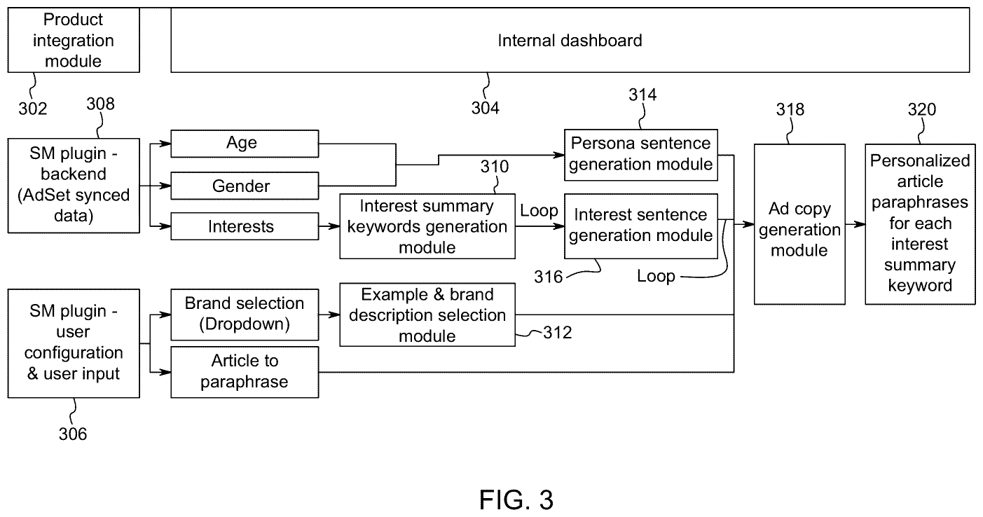

FIG. 3 illustrates a block diagram for generation of personalized paraphrases by an ad copy generation module 318 (similar in functioning to ad copy generation module 110), according to an embodiment. In the illustrated embodiment, the ad copy generation module 318 may be in communication with a social media platform or a search engine via a product integration module 302. A social media plugin 306 may be deployed by the ad copy generation module 318 to facilitate user configuration and provide user inputs to the ad copy generation module 318 via an internal dashboard 304. Another social media plugin 308 may communicate data such as, but not limited to, user interests, age groups, and gender associated with potential target audience to a persona sentence generation module 314 in communication with the ad copy generation module 318. In one example, this data may be based on one or more previous ad campaigns executed by the user on the social media platform. The persona sentence generation module 314 may create personalized sentences based on similar personas/attributes of target audience (e.g. similar age, gender and/or interests associated with a target audience cohort).

An interest summary keywords generation module 310 in communication with the) ad copy generation module 318, may generate interest summary keywords (e.g. cluster labels) based on the user interests. The interest summary keywords generation module 310 and the persona sentence generation module 314 may be a physical or a logical component of the ad copy generation module 318. The interest summary keywords may be generated on a recurring basis based on when the user interests are received. Further, the interest sentence generation may also occur on a recurring basis depending on recurring interest summary keywords generation for various clusters of various target audience cohorts.

A user input module 312 in communication with the ad copy generation module 318 may then receive a user input (e.g. brand selection via a dropdown menu) to select one or more clusters for which paraphrases are required to be generated for subsequent ad copy generation.

On receiving the above-described inputs from the persona sentence generation module 314 (persona-based sentences), interest sentence generation module 316 (interest-based sentences), and the user input module 312 (brand/cluster selection), the ad copy generation module 318 may generate personalized paraphrases corresponding to each cluster or cluster label. In an embodiment, the ad copy generation module 318 may implement a language model or algorithm to personalize the sentences provided to the ad copy generation module 318. In one example, a paraphrase may be generated for each interest summary keyword and later, the user can select one or more paraphrases to be included in the ad copy corresponding to that cluster.

In an alternate embodiment, instead of receiving interests of a target audience, the ad copy generation module 318 may receive a set of keywords from a social media platform or a search engine. The ad copy generation module 318 may then create personas based on the received set of keywords and the age and gender of the target audience. The ad copy generation module 318 may then create paraphrases based on the set of keywords, age, and gender of the target audience by providing these parameters as inputs to the ad copy generation module 318.

A person skilled in the art would understand that the ad copy generation module 318 is not limited to perform the above-described functions. The embodiments presented herein may also allow the ad copy generation module 318 to perform functions performed by any or all of the components/modules illustrated in FIG. 3.

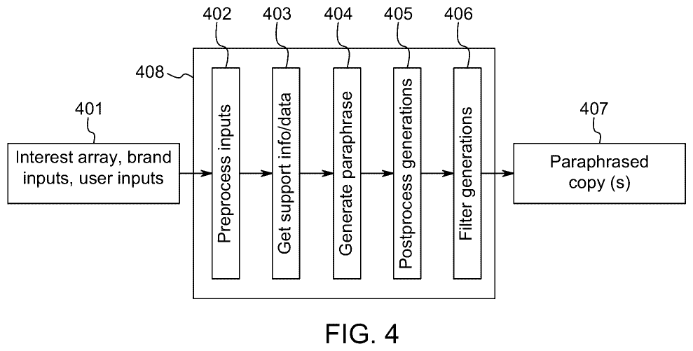

FIG. 4 illustrates an example implementation of the ad copy generation module 110, according to an embodiment. In an embodiment, the ad copy generation module 110 may receive inputs 401 such as, but not limited to, an interest array indicating one or more user interests, brand inputs and user inputs, as described in the context of FIG. 3. The ad copy generation module 110 may preprocess 402 the received inputs. The ad copy generation module 110 may further receive support data 403 to generate paraphrases 404, as described in the context of FIG. 3. The ad copy generation module 110 then performs postprocessing operations 405 on the generated paraphrases and filters 406 the paraphrases to select one or more paraphrases 407. The ad copy generation module 110 then includes these paraphrases in the ad copies for a specific target audience cohort.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD-ROMs, DVDs, flash drives, disks, and any other known physical storage media.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

1. A method for digital search optimization, the method comprising:
clustering a set of keywords into at least one cluster;
determining a target audience cohort for a corresponding one of the at least one cluster; and
generating a personalized advertisement (ad) copy corresponding to the determined target audience cohort, wherein each personalized ad copy comprises a headline and a description, wherein the headline and the description have at least one keyword from the corresponding one of the at least one cluster, and wherein generating the personalized ad copy corresponding to the determined target audience cohort comprises generating one or more paraphrases based on at least one interest summary keyword and a persona sentence.

2. The method of claim 1, further comprising receiving the set of keywords from one of a user, a search engine, or a social media platform.

3. The method of claim 1, wherein the clustering is performed based on at least one of; a set of brand names associated with the set of keywords, a set of competitor brand names associated with the set of keywords, a similarity among at least two keywords from the set of keywords, and a search volume associated with the set of keywords.

4. The method of claim 1, further comprising assigning a label to each of the at least one cluster, wherein the assigning comprises:
determining that a frequency of occurrence of at least one keyword in a corresponding one of the at least one cluster is above a predetermined threshold;
determining a frequency of occurrence of the at least one keyword in at least one other cluster from the at least one cluster;
selecting one of the at least one keyword that has a lowest frequency of occurrence in the at least one other cluster; and
assigning the selected keyword as the label for the corresponding one of the at least one cluster.

5. The method of claim 1, further comprising receiving a user input to perform at least one of: editing at least one keyword in the at least one cluster, editing at least one label associated with at least one of the at least one cluster, and selecting at least one of the at least one cluster for generating corresponding personalized ad copies.

6. The method of claim 1, wherein generating the personalized ad copy corresponding to the determined target audience cohort comprises:
identifying the at least one interest summary keyword in a corresponding one of the at least one cluster based on user interests of the target audience cohort;
generating the persona sentence based on a persona of the target audience cohort;
selecting at least one of the one or more generated paraphrases based on a relevance check and a grammar check on the one or more generated paraphrases; and
generating the headline and the description of the personalized ad copy based on the selected at least one paraphrase.

7. The method of claim 6, wherein generating the one or more paraphrases comprises implementing a pre-trained language algorithm.

8. The method of claim 1, further comprising generating a recommendation including the target audience cohort.

9. The method of claim 8, wherein the recommendation further comprises an age group, a gender, a location, and/or an interest profile associated with the target audience cohort.

10. A digital search optimization system, the system comprising:
a clustering module configured to cluster a set of keywords into at least one cluster;
a targeting AI module configured to determine a target audience cohort for a corresponding one of the at least one cluster; and
an advertisement (ad) copy generation module configured to generate a personalized ad copy corresponding to the determined target audience cohort, wherein each personalized ad copy comprises a headline and a description, wherein the headline and the description have at least one keyword from the corresponding one of the at least one cluster, and wherein the ad copy generation module is configured to generate one or more paraphrases based on at least one interest summary keyword and a persona sentence.

11. The system of claim 10, wherein the clustering module is further configured to receive the set of keywords from a user via an ad engine, a search engine, or a social media platform.

12. The system of claim 11, wherein the clustering module is further configured to receive a user input to at least one of; edit at least one keyword in the at least one cluster, edit at least one label associated with at least one of the at least one cluster, and select at least one of the at least one cluster to generate corresponding personalized ad copies.

13. The system of claim 11, wherein the clustering module is further configured to assign a label to each of the at least one cluster, wherein the clustering module is further configured to:
determine that a frequency of occurrence of at least one keyword in a corresponding one of the at least one cluster is above a predetermined threshold;
determine a frequency of occurrence of the at least one keyword in at least one other cluster from the at least one cluster;
select one of the at least one keyword that has a lowest frequency of occurrence in the at least one other cluster; and
assign the selected keyword as the label for the corresponding one of the at least one cluster.

14. The system of claim 10, wherein the ad copy generation module is further configured to:
identify the at least one interest summary keyword in a corresponding one of the at least one cluster based on user interests of the target audience cohort;
generate the persona sentence based on a persona of the target audience cohort;
select at least one of the one or more generated paraphrases based on a relevance check and a grammar check on the one or more generated paraphrases; and
generate the headline and the description of the personalized ad copy based on the selected at least one paraphrase.

15. The system of claim 10, wherein the targeting AI module is configured to generate a recommendation including the target audience cohort.
